(19) United States
(12) Patent Application Publication
(10) Pub. No.: US 2026/0099914 A1
(43) Pub. Date: Apr. 9, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: TOSHIYUKI SANO, Tokyo (JP)

(21) Appl. No.: 19/340,165

(22) Filed: Sep. 25, 2025

(30) Foreign Application Priority Data
Oct. 7, 2024 (JP) 2024-176163

(51) Int. Cl. G06T 7/00; H04N 23/71

(52) U.S. Cl. CPC G06T 7/001; H04N 23/71

(57) ABSTRACT

An image processing apparatus acquires a brightness of an image captured by imaging a reference reflection plate when a plurality of light sources is sequentially turned on, acquires a brightness of a reference corresponding to the brightness of the image, determines whether a respective state of each light source included in the plurality of light sources is normal or abnormal based on the brightness of the image and the brightness of the reference, and, in a case where the state of a light source included in the plurality of light sources is abnormal, identifies a type of abnormality.

### BACKGROUND

### Field of the Technology

The present disclosure relates to an inspection technique using an image.

### Description of the Related Art

A technique is known for inspecting the appearance of industrial products by capturing images of the target object while sequentially illuminating a plurality of light sources, and detecting defects based on a plurality of captured images taken under different lighting directions. In such inspection techniques, in a case where the illuminance of each of the light sources is not appropriate, it may affect the accuracy of defect detection. For example, in the case of light-emitting diode (LED) light sources, it is known that illuminance decreases over time as the lighting duration increases.

If such a light source is included in the inspection, the accuracy of defect inspection may deteriorate. As a technique for detecting the degradation of a light source, for example, Japanese Patent Laid-open No. 2010-113986 is known. More specifically, Japanese Patent Laid-open No. 2010-113986 describes a technique in which the illuminance emitted by an LED element is recorded using an illuminance sensor, and when the measured illuminance during emission falls below a set value, it notifies that the light source has reached the end of its service life.

In general, a change in illuminance on the inspection target is not necessarily attributable solely to degradation of the light source. For example, illuminance may also change if the orientation of the installed light source is altered, such as by accidental contact. In a case where a light source has degraded, the issue can be addressed by replacing the light source with a new one. However, when the orientation of the light source has changed, corrective action to restore the original lighting direction is required. As described above, as the appropriate countermeasure depends on the cause of the illuminance change, it is therefore important to identify the cause of the change. However, the technique described in Japanese Patent Laid-open No. 2010-113986 cannot identify the cause of the illuminance change.

### SUMMARY

Embodiments of the present disclosure are directed to a technique for identifying a cause of an illuminance change on an inspection target in an appearance inspection.

According to an aspect of the present disclosure, an image processing apparatus includes at least one processor and at least one memory that is in communication with the at least one processor. The at least one memory stores instructions for causing the at least one processor and the at least one memory to acquire a brightness of an image captured by imaging a reference reflection plate when a plurality of light sources is sequentially turned on, acquire a brightness of a reference corresponding to the brightness of the image, determine whether a respective state of each light source included in the plurality of light sources is normal or abnormal based on the brightness of the image and the brightness of the reference, and, in a case where the respective state of a light source included in the plurality of light sources is abnormal, identify a type of abnormality.

Features of various embodiments of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an example of a hardware configuration of an inspection system.

FIGS. 2A and 2B are diagrams illustrating an appearance of the inspection system.

FIG. 3 is a block diagram illustrating a functional configuration of an image processing apparatus.

FIG. 4 is a flowchart illustrating processing executed by the image processing apparatus.

FIG. 5 is a diagram illustrating a geometric condition between a reference reflection plate, light sources, and an image capturing apparatus.

FIG. 6 is a diagram illustrating an example of a user interface.

FIGS. 7A, 7B, and 7C are diagrams illustrating light source state determination processing.

FIG. 8 is a flowchart illustrating light source state determination processing.

FIG. 9 is a diagram illustrating an example of a user interface.

FIG. 10 is a flowchart illustrating light source state determination processing.

FIG. 11 is a diagram illustrating an example of determination areas.

FIG. 12 is a diagram illustrating a geometric condition between a reference reflection plate, light sources, and an image capturing apparatus.

FIGS. 13A, 13B, and 13C are diagrams illustrating light source state determination processing.

FIG. 14 is a flowchart illustrating light source state determination processing.

### DESCRIPTION OF THE EMBODIMENTS

Hereinbelow, embodiments of the present disclosure will be described with reference to the attached drawings. Note that the following embodiments are not necessarily intended to limit every embodiment of the present disclosure. In addition, note that all the combinations of the features described in the following embodiments are not necessarily essential to the solutions disclosed herein.

### First Embodiment

### <Hardware Configuration of Image Processing Apparatus>

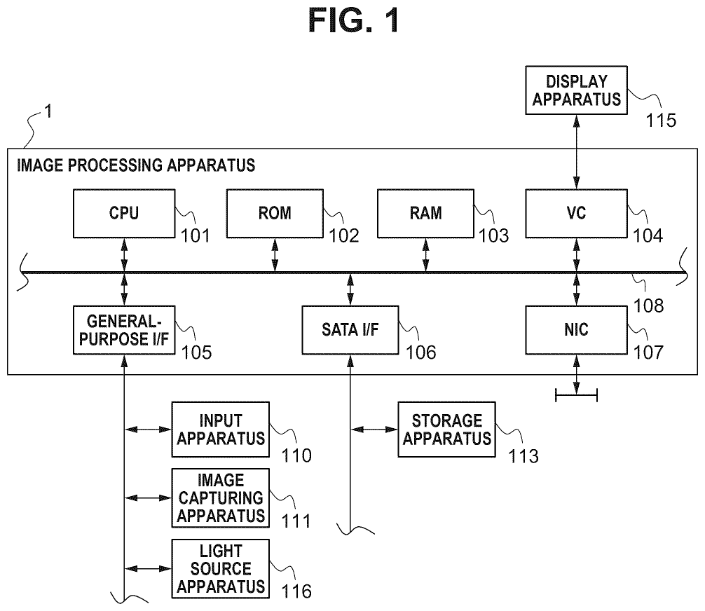

With reference to a block diagram illustrated in FIG. 1, an example of a hardware configuration of an inspection system according to the present embodiment will be described. The inspection system according to the present embodiment includes an image processing apparatus 1, a display apparatus 115, an input apparatus 110, an image capturing apparatus 111, a light source apparatus 116, and a storage apparatus 113.

A central processing unit (CPU) 101 executes various kinds of processing using computer programs and data stored in a random access memory (RAM) 103. With this operation, the CPU 101 executes or controls various kinds of processing, which is described as processing to be executed by the image processing apparatus 1, while performing the operation control on the image processing apparatus 1. A read only memory (ROM) 102 stores setting data for the image processing apparatus 1, a computer program and data related to an activation of the image processing apparatus 1, and a computer program and data related to a basic operation of the image processing apparatus 1. The RAM 103 includes an area for storing a computer program and data loaded from the ROM 102 or the storage apparatus 113, and an area for storing captured images output from the image capturing apparatus 111. Further, the RAM 103 includes a work area used when the CPU 101 performs various kinds of processing. As described above, the RAM 103 can appropriately provide the various kinds of areas.

The display apparatus 115 is connected to a video card (VC) 104. For example, the CPU 101 can output a result of processing by the CPU 101 to the display apparatus 115 via the VC 104 to display the result of processing using images and text on the display apparatus 115. The display apparatus 115 is a display apparatus including a liquid crystal screen and a touch panel screen. In addition, the display apparatus 115 may be a projection apparatus such as a projector. The input apparatus 110, the image capturing apparatus 111, and the light source apparatus 116 are connected to a general-purpose interface (I/F) 105.

The input apparatus 110 is a user interface (UI), such as a keyboard, a mouse, and a touch panel, and a user can input various kinds of instructions and information to the image processing apparatus 1 by operating the input apparatus 110. The image capturing apparatus 111 is an apparatus for capturing an image of an inspection target object. The image capturing apparatus 111 may be an image capturing apparatus capturing still images at regular or irregular intervals, or may be an image capturing apparatus capturing moving images. The light source apparatus 116 is an apparatus for emitting light to an inspection target object, and includes a plurality of light sources. The storage apparatus 113 is connected to a Serial Advanced Technology Attachment (SATA) I/F 106. The CPU 101 reads and writes computer programs and data from and to the storage apparatus 113 via the SATA I/F 106. The storage apparatus 113 is a nonvolatile storage apparatus, such as a hard disk drive. The storage apparatus 113 stores computer programs and data for causing the CPU 101 to execute or control various kinds of processing, which is described as processing to be performed by an operating system (OS) or the image processing apparatus 1.

Further, the image processing apparatus I can connect to a network, such as a local area network (LAN) or the Internet, via a network interface card (NIC) 107 to perform data communication with an apparatus on the network. The image processing apparatus 1 may acquire part or all of the information to be used for each process described below from an apparatus on the network via the NIC 107. All of the CPU 101, the ROM 102, the RAM 103, the VC 104, the general-purpose I/F 105, the SATA I/F 106, and the NIC 107 are connected to a system bus 108. In addition, the image processing apparatus 1 may be implemented using a computer apparatus such as a personal computer (PC), a smartphone, a tablet terminal. In addition, the configuration of the inspection system illustrated in FIG. 1 is just an example, and, for example, two or more apparatuses of the apparatuses illustrated in FIG. 1 may be combined to configure the system.

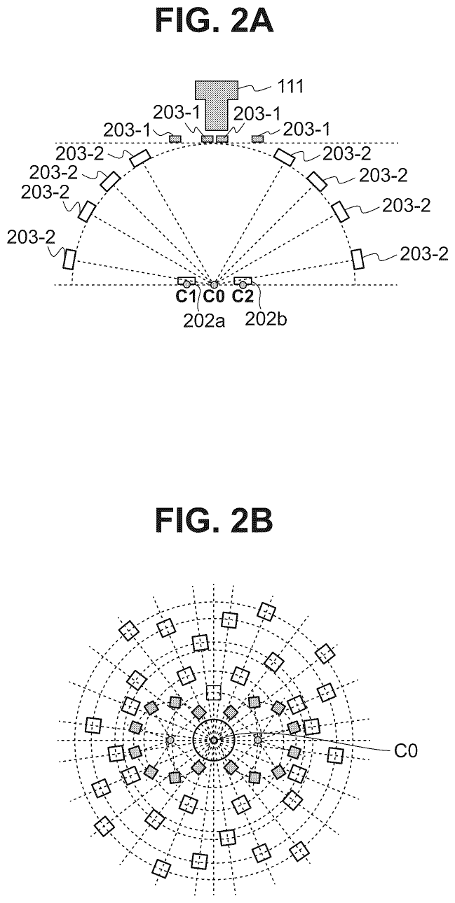

Next, with reference to FIG. 2, an arrangement example of the image capturing apparatus 111 and the light source apparatus 116, which are arranged to inspect the glossiness, color, and unevenness of the surface of an inspection target object, will be described. The light source apparatus 116 includes gloss inspection light sources 203-1 emitting light to an inspection target object to inspect the gloss of the inspection target object, and color/unevenness inspection light sources 203-2 emitting light to the inspection target object to inspect the color and unevenness of the inspection target object.

In the present embodiment, as illustrated in FIG. 2A, there are two inspection targets: an inspection target 202a and an inspection target 202b. The inspection target 202a is disposed at a position C1, and the inspection target 202b is disposed at a position C2. The gloss inspection light sources 203-1 and the color/unevenness inspection light sources 203-2 are arranged around the two inspection targets 202a and 202b and emit light to the two inspection targets. The image capturing apparatus 111 simultaneously captures images of the two inspection targets 202a and 202b irradiated with the light from the gloss inspection light sources 203-1 and the color/unevenness inspection light sources 203-2. In this case, the simultaneous image capturing means that the image capturing apparatus 111 captures an image in a state where the two inspection targets 202a and 202b are included in an angle of view of the image capturing apparatus 111. The image processing apparatus 1 inspects the two inspection targets 202a and 202b for their glossiness, colors, and unevenness based on the captured image obtained through the image capturing.

In the present embodiment, the LEDs are used for the light sources 203-1 and 203-2 of the light source apparatus 116, but the type of the light sources is not limited to a specific type, and another type of light sources, for example, a xenon lamp or the like, may be used. Further, surface light sources, each having a plurality of LEDs arranged thereon, may be used as the light sources. Further, in the inspection of the inspection target object using a silhouette image, the light irradiation method may be changed depending on an appearance inspection item of the inspection target object.

When the color or the unevenness of the inspection target object is inspected, the light may be emitted from a direction in which the specular reflection light from the inspection surface of the inspection target object is not captured. The color/unevenness inspection light sources 203-2 are arranged in a direction in which the angle formed by an incident vector of the light irradiating the inspection target object, and a normal vector of the inspection target object irradiated with the light becomes relatively large. More specifically, the color/unevenness inspection light sources 203-2 are arranged so that the image capturing apparatus 111 receives the diffuse reflection light. In addition, the color/unevenness inspection light sources 203-2 are sequentially turned on one by one, and the image capturing is performed in synchronization with the time at which each color/unevenness inspection light source 203-2 is turned on.

When the glossiness of the inspection target is inspected, the light can be emitted from a direction in which the reflected light in the vicinity of the specular reflection light from the inspection surface of the inspection target object can be captured. The gloss inspection light sources 203-1 are arranged in a direction in which the angle formed by an incident vector of the light irradiating the inspection target object, and a normal vector of the inspection target object irradiated with the light becomes relatively small. More specifically, the gloss inspection light sources 203-1 are arranged so that the image capturing apparatus 111 receives the specular reflection light. In addition, the light sources serving as the gloss inspection light sources 203-1 are simultaneously turned on, and the image capturing is performed in synchronization with the lighting timing.

The inspection image consisting of the normal line information representing the unevenness, and the color information corresponding to reflectance ratios can be generated, by combining the captured images of the inspection target objects irradiated by the plurality of light sources in the plurality of directions, using a known photometric stereo method.

FIG. 2B is a top view illustrating the arrangement of the light sources according to the present embodiment. As illustrated in FIG. 2B, in the present embodiment, 8 light sources arranged evenly on each of the right and left sides of an image capturing center C0, i.e., a total of 16 light sources, are used as the gloss inspection light sources 203-1. In the following descriptions, the 16 light sources serving as the gloss inspection light sources 203-1 are regarded as one light source. Further, 31 light sources arranged around the inspection targets 202a and 202b (hereinbelow, may be collectively referred to as an inspection target object 202) are used as the color/unevenness inspection light sources 203-2. However, the number of light sources used for the inspection is not limited thereto. For example, the number of the gloss inspection light sources 203-1 may be increased or reduced, and the number of the color/unevenness inspection light sources 203-2 may be increased or reduced. Further, if 3 or more light sources are arranged, the arrangement method is not limited thereto.

### <Functional Configuration of Image Processing Apparatus>

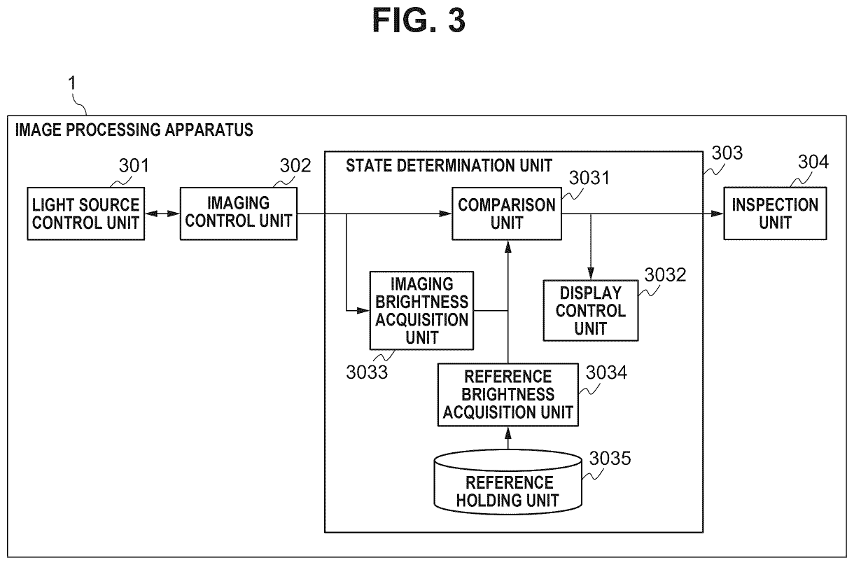

FIG. 3 is a block diagram illustrating a functional configuration of the image processing apparatus 1. The image processing apparatus 1 includes a light source control unit 301, an imaging control unit 302, a state determination unit 303, and an inspection unit 304. The state determination unit 303 includes a comparison unit 3031, a display control unit 3032, an imaging brightness acquisition unit 3033, a reference brightness acquisition unit 3034, and a reference holding unit 3035. The light source control unit 301 controls the light source apparatus 116. The imaging control unit 302 controls the image capturing apparatus 111. The state determination unit 303 determines the state of each of the light sources used for the inspection. The inspection unit 304 performs inspection processing based on the captured image.

### <Processing Performed by Image Processing Apparatus>

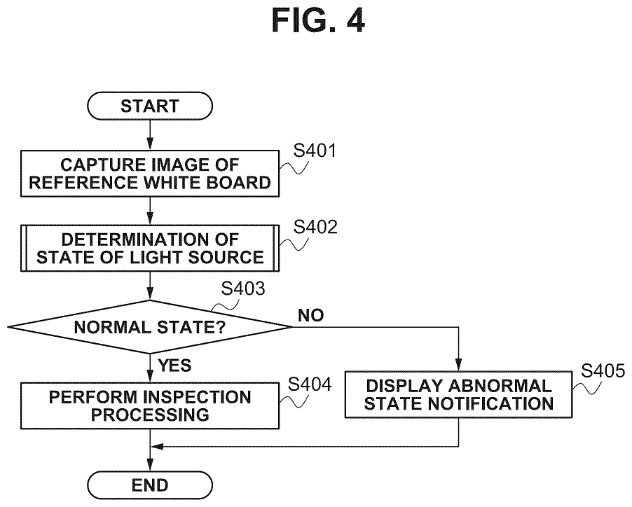

With reference to a flowchart in FIG. 4, a flow of processing to be performed by the image processing apparatus 1 according to the present embodiment will be described. The processing illustrated in FIG. 4 starts when a user inputs an instruction via the input apparatus 110, and the CPU 101 receives the input instruction.

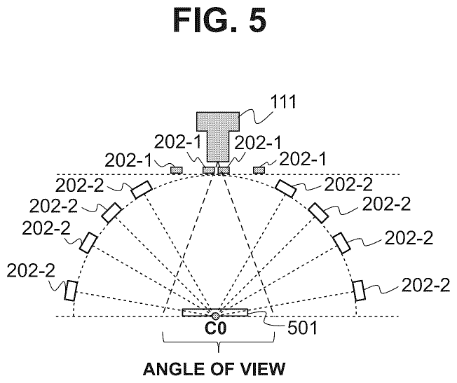

In step S401, the imaging control unit 302 captures an image of a reference reflection plate (reference white board) 501 set for a light source state determination, in synchronization with the light source control unit 301 turning on the light sources. FIG. 5 is a diagram illustrating a geometric condition between the reference reflection plate 501, the light sources, and the image capturing apparatus 111 according to the present embodiment. As illustrated in FIG. 5, the reference reflection plate 501 is set at the image capturing center C0. In addition, it is desirable that the reference reflection plate 501 have a relatively large size, and in the present embodiment, a reference reflection plate having a size equivalent to 75% of the angle of view is used.

In step S402, the state determination unit 303 determines the state of each of the light sources used for the object appearance inspection, based on the image captured in step S401. In addition, the state determination unit 303 according to the present embodiment determines whether the state is a “normal state” in which the inspection can be performed normally, or an “abnormal state” in which the inspection cannot be performed normally. Further, with regard to abnormalities, the state determination unit 303 determines the type of abnormality as either “deteriorated state” in which the illuminance decreases due to aging and the inspection cannot be performed normally, or “abnormal orientation” in which the angle of the light source deviates from the expected orientation due to the factors such as contact with the light source. Details of the processing performed in step S402 will be described below. In step S403, the state determination unit 303 determines whether the state determined in step S402 is a “normal state”. In a case where each of the light sources is in a normal state (YES in step S403), the processing proceeds to step S404. Otherwise (NO in step S403), the processing proceeds to step S405.

In step S404, the inspection unit 304 performs an inspection of the inspection target object 202. More specifically, first, the light source control unit 301 turns on all the gloss inspection light sources 203-1 together to irradiate the inspection target object 202. The imaging control unit 302 causes an image capturing apparatus 201 to capture an image of the inspection target object 202 in synchronization with the gloss inspection light sources 203-1 being turned on. Next, the light source control unit 301 sequentially turns on the color/unevenness inspection light sources 203-2 to irradiate the inspection target object 202. The imaging control unit 302 causes the image capturing apparatus 201 to capture the image of the inspection target object 202 in synchronization with each of the color/unevenness inspection light sources 203-2 being turned on. In the present embodiment, since the inspection system includes 31 color/unevenness inspection light sources 203-2, the image capturing using the gloss inspection light sources 203-1 is performed once, and the image capturing using the color/unevenness inspection light sources 203-2 is performed 31 times (i.e., total 32 times). In the present embodiment, the image capturing is performed using all the light sources, but the number of times of the image capturing is not limited thereto. For example, to speed up the inspection, the number of times of the image capturing may be reduced by, for example, setting effective light sources in advance depending on the inspection target object 202. In this case, the effective light sources refer to, for example, light sources that can minimize the shadowed areas according to the height of the inspection target object 202, or light sources that allow the image capturing apparatus 201 to easily receive the reflected light near the specular reflection. Further, for example, the image capturing apparatus 201 may perform image capturing a plurality of times while one light source is turned on, so as to reduce the influence of noise.

Next, the inspection unit 304 combines the 31 images captured using the color/unevenness inspection light sources 203-2 by a known photometric stereo method, to generate a normal line image representing the unevenness of the inspection target, and a color image corresponding to the reflectance. Further, the inspection unit 304 generates a gloss image expressing a gloss intensity at each position of the inspection target object 202 based on one image captured using the gloss inspection light sources 203-1. The inspection unit 304 detects a defect by applying spatial filter processing on each of the normal line image, the color image, and the gloss image. In the present embodiment, the inspection unit 304 calculates a value as an abnormal degree, by integrating the response values obtained by the spatial filtering processing applied to the inspection images and converting the response values into a numerical form. In addition, depending on the magnitude of the calculated abnormal degree, an error notification or the like may be provided to a user via the display apparatus 115.

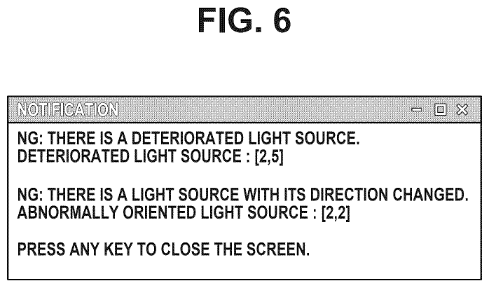

In step S405, the display control unit 3032 notifies the user of the light source determined to be in the “abnormal state” via the display apparatus 115. FIG. 6 illustrates an example of a user interface (UI) displayed in step S405.

As illustrated in FIG. 6, the UI in FIG. 6 represents to the user the numbers of the light sources determined to be in the “abnormal state”, which are categorized by the type of abnormality.

### <Details of Processing Performed in Step S402>

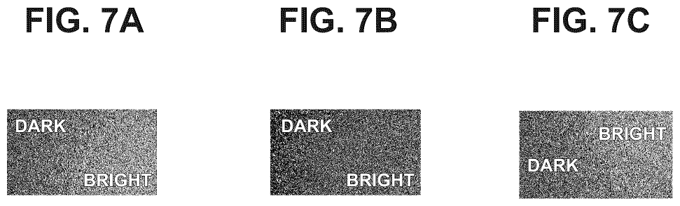

First, with reference to FIGS. 7A, 7B, and 7C, a basic idea about the processing in step S402 will be described. FIGS. 7A, 7B, and 7C are diagrams each illustrating an example of an image in a case where brightness levels of the light sources change. FIG. 7A illustrates a captured image obtained by capturing an image of the inspection target object 202 in a state where the light sources in a normal state, i.e., in a state where the light sources are not deteriorated or their orientations are normal, are turned on. As illustrated in FIG. 7A, the captured image is dark on the upper left side, and is bright on the lower right side. FIG. 7B illustrates a captured image obtained by capturing the inspection target object 202 in a state where the light sources that are set at the same positions as in FIG. 7A and had deteriorated over time are turned on. It can be seen that the image in FIG. 7B is entirely darker than the image in FIG. 7A, but the relative brightness level in the image is dark on the upper left side, and is bright on the lower right side, similar to the image in FIG. 7A. FIG. 7C illustrates a captured image obtained by capturing the inspection target object 202 in a state where the light sources arranged at the same positions as in FIG. 7A, but with their orientations slightly tilted away from the imaging capturing center C0, are turned on. The image in FIG. 7C is bright on the upper right side and dark on the lower left side, and it can be seen that the spatial distribution of relative brightness is different from that of the image in FIG. 7A. The processing in step S402 is processing for determining the state including the cause of the change in the brightness of the light sources based on the above-described characteristics.

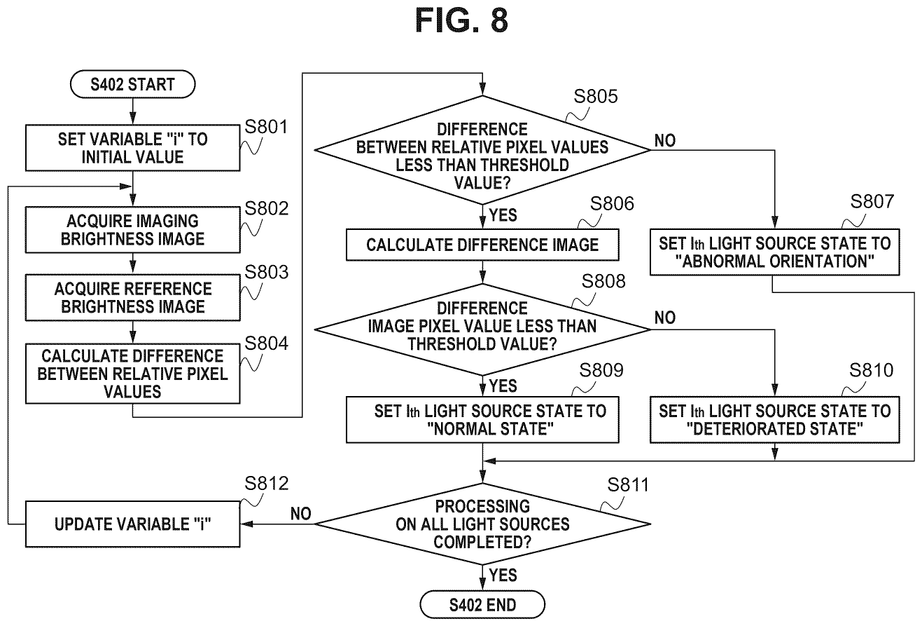

FIG. 8 is a flowchart illustrating the light source state determination processing performed in step S402. In step S801, the comparison unit 3031 sets a variable “i” indicating a light source number to an initial value. In the present embodiment, i=1 indicating the first light source number is set. In this case, all of the gloss inspection light sources 203-1, when turned on together, are regarded as a single light source. In step S802, the imaging brightness acquisition unit 3033 acquires an imaging brightness image Ii, which is a two-dimensional map of the brightness values obtained by capturing the image of the inspection target object 202 while the i-th light source is turned on. In step S803, the reference brightness acquisition unit 3034 acquires a reference brightness image Ri corresponding to the i-th light source from the reference holding unit 3035. In this case, the reference brightness image Ri corresponding to the i-th light source according to the present embodiment is a captured image obtained by capturing the inspection target object 202 for the first time while the i-th light source is turned on, i.e., a two-dimensional map of the brightness values. The captured image in the present embodiment is an 8 bit gray scale image, but it is not limited thereto. For example, the captured image may be a 16 bit image, and may be a color image. In a case of a color image, the color image may be converted into a brightness image using a known brightness conversion. Alternatively, the pixel values of a specific channel (e.g., G channel) may be regarded as the brightness values.

In step S804, the comparison unit 3031 calculates relative values Ii_ref at all of the pixel positions (x, y) of the imaging brightness image Ii acquired in step S802, using the following equation (1).

$$Ii\_ref ( x , y ) = Ii ( x , y ) / max ( Ii ( x , y ) ) \qquad Equation ( 1 )$$

In addition, max (I(x, y)) is a maximum pixel value at a position among all of the pixel positions in the imaging brightness image I. Further, the comparison unit 3031 calculates relative values Ri_ref at all the pixel positions (x, y) of the reference brightness image Ri acquired in step S803, using the following equation (2).

$$Ri\_ref ( x , y ) = Ri ( x , y ) / max ( Ri ( x , y ) ) \qquad Equation ( 2 )$$

Then, the comparison unit 3031 calculates a difference ΔRef(x, y) between the relative value Ii_ref(x, y) and the relative value Ri_ref(x, y), using the equation (3) shown below. In the equation (3), |a| indicates an absolute value of “a”. The processing in step S804 corresponds to processing for calculating a difference between the relative pixel values to compare the imaging brightness image I and the reference brightness image R.

$$Δ Ref ( x , y ) = \vert Ii\_ref ( x , y ) - Ri\_ref ( x , y ) \vert \qquad Equation ( 3 )$$

In step S805, the comparison unit 3031 determines whether the ΔRef(x, y) calculated in step S804 is less than a threshold value set in advance. In a case where the ΔRef(x, y) is less than the threshold value (YES in step S805), the comparison unit 3031 determines that the spatial distribution of the pixel value is similar, and the processing proceeds to step S806. Otherwise (NO in step S805), the processing proceeds to step S807. In step S806, the comparison unit 3031 calculates a difference image ΔI between the imaging brightness image I and the reference brightness image R using the following equation (4).

$$Δ I ( x , y ) = \vert Ii ( x , y ) - Ri ( x , y ) \vert \qquad Equation ( 4 )$$

In step S807, since the imaging brightness image I and the reference brightness image R are different in the spatial brightness distribution, the comparison unit 3031 determines that the orientation of the i-th light source is different, and sets the state of the i-th light source to the “abnormal orientation”. Then, the processing proceeds to step S811. In step S808, the comparison unit 3031 determines whether the difference between the relative brightness values calculated in step S806 is less than a threshold value. In a case where the difference is less than the threshold value (YES in step S808), the processing proceeds to step S809. Otherwise (NO in step S808), the processing proceeds to step S810. In step S809, the comparison unit 3031 determines that brightness values are approximately the same at all positions in the imaging brightness image I and the reference brightness image R, and sets the state of the i-th light source to the “normal state”. Then, the processing proceeds to step S811. In step S810, the comparison unit 3031 determines that the overall brightness between the imaging brightness image I and the reference brightness image R is different, and sets the state of the i-th light source to the “deteriorated state”. Then, the processing proceeds to step S811. In step S811, the comparison unit 3031 determines whether the processing is performed on all the numbers of the light sources. In a case where the processing is performed on all the numbers of the light sources (YES in step S811), the processing ends. Otherwise (NO in step S811), the processing proceeds to step S812. In step S812, the comparison unit 3031 updates the variable “i” indicating the number of the light source, and the processing returns to step S802.

As described above, the image processing apparatus 1 according to the present embodiment determines the state of each of the light sources by comparing the imaging brightness image and the reference brightness image corresponding to the light source. In this way, it is possible to perform the inspection without reducing the defect detection accuracy for the inspection target object.

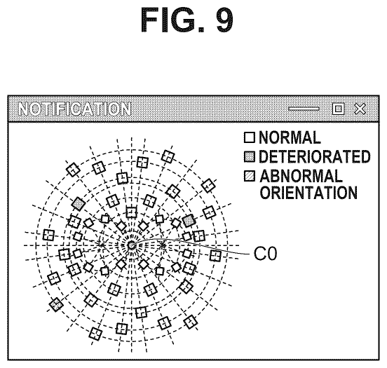

In the present embodiment, the display control unit 3032 performs the display as in the UI illustrated in FIG. 6. However, the display method is not limited thereto. For example, as illustrated in FIG. 9, the state of each of the light sources may be graphically displayed. In FIG. 9, each black square indicates the “deteriorated state”, and each hatched square indicates the “abnormal orientation”. This display allows the status of each light source and its placement position to be visually understood.

In addition, in the present embodiment, the reference brightness image R is the image obtained by capturing the inspection target object 202 when the light source is turned on for the first time. However, the generation method for the reference brightness image R is not limited thereto. For example, it is possible to theoretically calculate the brightness value based on the distance between each of the light sources and the inspection target object 202, the angle formed by each of the light sources and the inspection target object 202, and the brightness value of each of the light sources. In this case, each threshold value may be set in consideration of the difference between the theoretical value and the actual value.

In addition, in the present embodiment, the state determination is performed for all of the light sources, but the state determination may not be performed on all of the light sources. For example, in a case where it is known in advance that only specific light sources are used for a certain inspection target object, the light sources to be evaluated may be selected so that the state determination is performed for only those light sources.

### Second Embodiment

In the first embodiment, the whole imaging brightness image is compared with the reference brightness image to determine whether the light sources are in the normal state or the abnormal state. However, in a case where the comparison is performed based on the spatial brightness distribution difference, the whole of the brightness image may not be used for the comparison. For example, to speed up the determination, a plurality of discrete determination areas may be set in advance, and the states of the light sources may be determined based on the result of comparison between the brightness values of the reference reflection plate and the imaging brightness image at the same positions. In the present embodiment, the states of the light sources are determined using a plurality of areas set in advance. The hardware configuration and the functional configuration of the image processing apparatus 1 according to the present embodiment are similar to those according to the first embodiment, and the descriptions thereof are omitted. Hereinbelow, portions different between the present embodiment and the first embodiment will be mainly described. In addition, the same configurations as in the first embodiment will be described with the same references or symbols.

### <Details of Processing Performed in Step S402>

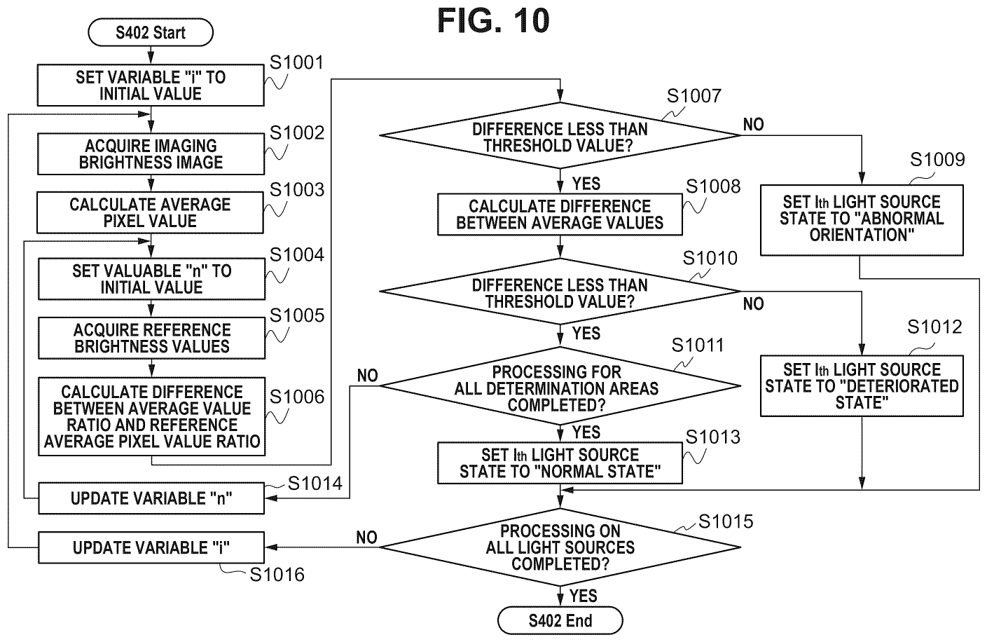

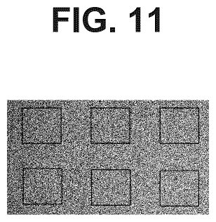

FIG. 10 is a flowchart illustrating the light source state determination processing performed in step S402. Processing in steps S1001 and S1002 is similar to that in steps S801 and S802 in the first embodiment, and the descriptions thereof are omitted. In step S1003, the comparison unit 3031 calculates the average value of the pixel values of the imaging brightness image Ii acquired in step S1002 for each of all the determination areas set in advance. In the present embodiment, as illustrated in FIG. 11, the processing is performed using 6 determination areas set in advance in the captured image. In step S1004, the comparison unit 3031 sets a valuable “n” indicating the number of the determination area to 1, which is the initial value. In step S1005, the reference brightness acquisition unit 3034 acquires the reference brightness value in the determination area “n” from the reference brightness image R of the i-th light source. In addition, the reference holding unit 3035 holds the average value of the pixel values for each determination area, calculated based on the captured image obtained when the inspection target object 202 is captured using the i-th light source for the first time. Further, the reference holding unit 3035 holds values each indicating a ratio of the average pixel value of the area to the maximum value of the average pixel values among all the areas. In step S1005, the reference brightness acquisition unit 3034 acquires, from the reference holding unit 3035, the average value Ref_An corresponding to the n-th area and the ratio Ref_Rn of the average pixel value of the area to the maximum value of the average pixel values.

In step S1006, the comparison unit 3031 calculates the ratio S_Rn of the average value of the determination area “n” to the maximum value of the average pixel values in all the areas calculated in step S1003, based on the equation (5) shown below. In addition, in the equation (5), Vave_n is an average pixel value in the n-th area of the imaging brightness image, and max(Vave_n) is the maximum value of the average pixel values in all the determination areas. In addition, S_Rn is a value corresponding to a relative brightness value.

$$S\_Rn = Vave\_n / max ( Vave\_n ) \qquad Equation ( 5 )$$

Next, the comparison unit 3031 calculates the difference ΔRn between S_Rn and Ref_Rn, which is the ratio of the average value of the reference brightness values in the determination area “n” acquired in step S1005 to the maximum value, based on the following equation (6).

$$Δ Rn = \vert S\_Rn - Ref\_Rn \vert \qquad Equation ( 6 )$$

In step S1007, the comparison unit 3031 determines whether the difference ARn is less than a threshold value.

In a case where the difference ARn is less than the threshold value (YES in step S1007), the processing proceeds to step S1008. Otherwise (NO in step S1007), the processing proceeds to step S1009. In step S1008, the comparison unit 3031 calculates the difference ΔVn between the average Vave_n in the determination area “n” of the imaging brightness image and the average value Ref_An acquired in step S1005, based on the equation (7) shown below. This makes it possible to perform comparison at the same position between the reference reflection plate and the imaging brightness image.

$$Δ Vn \vert Vave\_n - Ref\_An \vert \qquad Equation ( 7 )$$

Processing in step S1009 is similar to that in step S807, and the description thereof is omitted. In step S1010, the comparison unit 3031 determines whether the value of ΔVn calculated in step S1008 is less than a threshold value. In a case where the value of ΔVn is less than the threshold value (YES in step S1010), the processing proceeds to step S1011. Otherwise (NO in step S1010), the processing proceeds to step S1012.

In step S1011, the comparison unit 3031 determines whether the processing is performed for all the determination areas “n”. In a case where the processing for all the determination areas “n” is completed (YES in strep S1011), the processing proceeds to step S1013. Otherwise (NO in step S1011), the processing proceeds to step S1014. Processing in step S1012 is similar to that in step S810, and the description thereof is omitted. In step S1014, the comparison unit 3031 updates the variable “n” indicating the number of the determination area, and the processing returns to step S1004. Processing in steps S1013, S1015, and S1016 is similar to that in steps S809, S811, and S812, and thus, the descriptions thereof are omitted.

As described above, the image processing apparatus 1 according to the present embodiment determines the states of the light sources based on the differences in the spatial distribution of brightness by comparing the imaging brightness values and the reference brightness values at the same position using the discrete determination areas. In this way, it is possible to determine the states of the light sources faster than the case where the light sources are determined based on the whole image.

### Third Embodiment

In the above-described embodiment, the states of the light sources are determined using one reference reflection plate. However, the states of the light sources do not necessarily need to be determined using only one reference reflection plate. In the present embodiment, the states of the light sources are determined based on features of a plurality of differences at the same position among a plurality of reference plates arranged discretely. In addition, the hardware configuration and the functional configuration of the image processing apparatus 1 according to the present embodiment are similar to those according to the first embodiment, and the descriptions thereof are omitted. Hereinbelow, portions different between the present embodiment and the first embodiment will be mainly described. In addition, the same configurations as those in the first embodiment will be described with the same references or symbols.

### <Details of Processing Performed in Step S402>

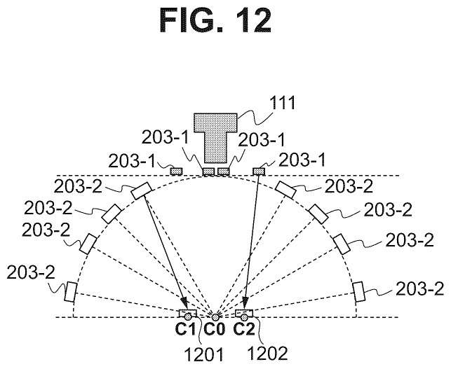

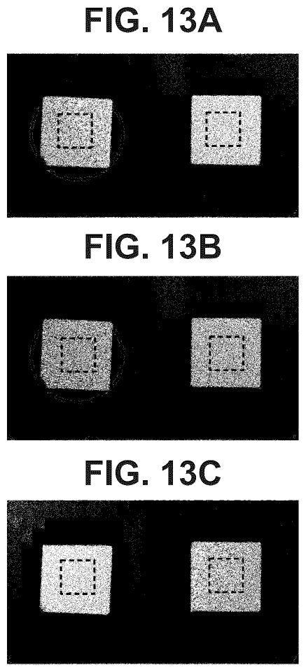

FIG. 12 is a diagram illustrating a geometric condition between reference reflection plates 1201 and 1202, the light sources 203-1 and 203-2, and the image capturing apparatus 111 according to the present embodiment. As illustrated in FIG. 12, in the present embodiment, two reference reflection plates, i.e., reference reflection plates 1201 and 1202, arranged so as to have equal intervals with respect to the image capturing center C0 are used. FIGS. 13A, 13B, and 13C illustrate examples of captured images obtained by the image capturing under the geometric condition in FIG. 12. In each of FIGS. 13A, 13B, and 13C, squares each surrounded by dotted lines indicate determination areas. The determination areas are areas of respective regions set inside the right and left reference reflection plates. FIG. 13A illustrates a captured image in a normal state.

The captured image is bright overall, and the pixel values in the determination area of the left reference reflection plate tend to be higher than those in the determination area of the right reference reflection plate. FIG. 13B illustrates a captured image acquired when the image capturing is performed in a state where the light sources located at the same positions as in FIG. 13A has darken due to aging deterioration. In FIG. 13B, the determination area in the right reference reflection plate tends to be bright, and the determination area in the left reference reflection plate tends to be dark, and the ratio of the average pixel value of the left reference reflection plate to that of the right reference reflection plate (i.e., relative relationship between pixel values) is similar to that in FIG. 13A. On the other hand, it can be seen that the overall brightness levels of the right and left reference reflection plates are darker than those in FIG. 13A.

FIG. 13C illustrates a captured image captured in a case where the orientations of the light sources located at the same positions as in FIG. 13A have changed. In FIG. 13C, the pixel values in the determination area of the left reference reflection plate are smaller than the pixel values in the determination area of the right reference reflection plate, and the ratio of the pixel values in the left reference reflection plate to the pixel values in the right reference reflection plate has a feature different from that in the normal state or the aging deteriorated state. In the present embodiment, the states of the light sources are determined using two reference reflection plates and two areas based on the above-described feature.

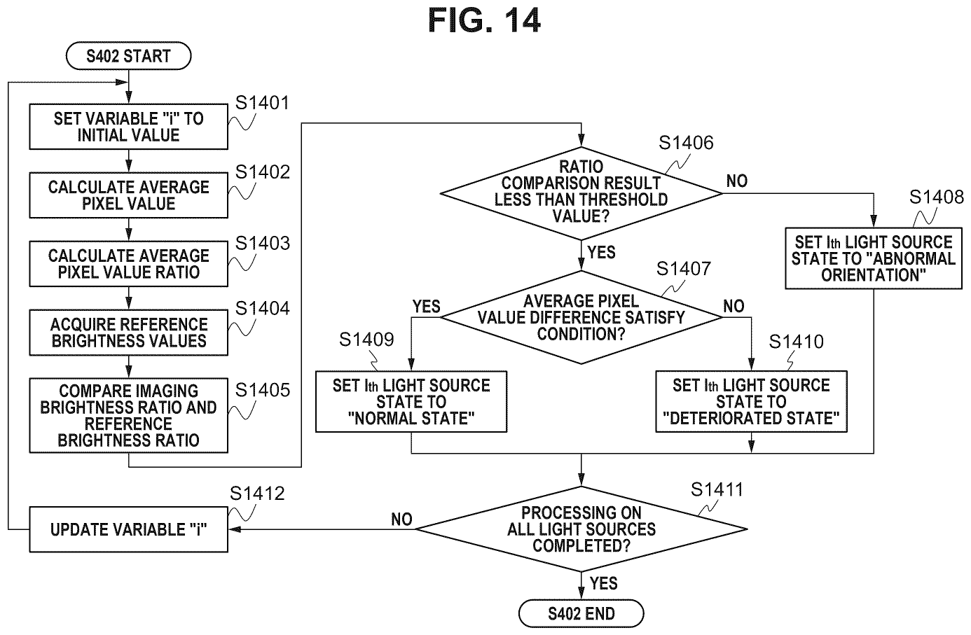

FIG. 14 is a flowchart illustrating the light source state determination processing performed in step S402. Processing in step S1401 is similar to that in step S801, and the description thereof is omitted. In step S1402, the comparison unit 3031 calculates an average pixel value for each of the right and left determination areas of the i-th imaging brightness image.

The average pixel value of the left determination area is defined as Iave_left_i, and the average pixel value of the right determination area is defined as Iave_right_i. In step S1403, the comparison unit 3031 calculates a ratio SRi of the average imaging brightness value of the left determination area to the average imaging brightness value of the right determination area calculated in step S1402. The ratio is calculated using the equation (5).

In step S1404, the reference brightness acquisition unit 3034 acquires reference brightness values corresponding to the i-th light source. In the present embodiment, the reference holding unit 3035 holds the average values of the brightness values in the right and left determination areas calculated based on the captured image acquired when the objects (reference reflection plates) 1201 and 1202 are captured for the first time using the i-th light source. Further, the reference holding unit 3035 holds a value indicating the ratio of the average brightness value of the left determination area to that of the right determination area. The reference brightness acquisition unit 3034 acquires the left average brightness value Ref_left_i and the right average brightness value Ref_right_i each corresponding to the i-th light source, from the reference holding unit 3035. Further, the reference brightness acquisition unit 3034 acquires a ratio Ref_Ratio_i of the average brightness value of the area to the maximum value of the average pixel values, from the reference holding unit 3035.

In step S1405, the comparison unit 3031 compares the imaging brightness value ratio SRi calculated in step S1403 and the reference brightness value ratio Ref_Ratio_i, based on the equation (8) shown below. In addition, the processing in step S1405 corresponds to the processing to understand a relative relationship of the brightness values between the imaging brightness image and the reference brightness image.

$$Score = \vert SRI - Ref\_Ratio \_i \vert \qquad Equation ( 8 )$$

In step S1406, the comparison unit 3031 determines whether the Score calculated in step S1405 is less than a threshold value. In a case where the Score is less than the threshold value (YES in step S1406), the processing proceeds to step S1407. Otherwise (NO in step S1406), the processing proceeds to step S1408. In step S1407, the comparison unit 3031 determines whether the Iave_left_i and the Iave_right_i calculated in step S1402, and the Ref_left_i and the Ref_right_i acquired in step S1404 satisfy the inequality (9) shown below. In a case where the inequality (9) is satisfied (YES in step S1407), the processing proceeds to step S1409. Otherwise (NO in step S1407), the processing proceeds to step S1410.

$$\vert Iave\_left \_i - Ref\_left \_i \vert < Th or \vert Iave\_right \_i - Ref\_right \_i \vert < Th \qquad Inequality ( 9 )$$

Processing in steps S1408 to S1412 is similar to that in step S807 and steps S809 to S812, and the descriptions thereof are omitted.

As described above, the image processing apparatus 1 according to the present embodiment determines the states of the light sources using the reference reflection plates arranged discretely at two positions. In this way, it is possible to determine the states of the light sources with an equivalent accuracy based on the configuration different from those in the above-described embodiments.

### Other Embodiments

In the above-described embodiments, the states of the light sources are classified into the three states of the “normal state”, the “deteriorated state”, and the “abnormal orientation”, but the states of the light sources are not limited to the above-described three states. For example, in a case where dust or the like adheres to a light source, the brightness value of the entire light source is decreased similar to the “aging deterioration”. In this case, the states of the light sources may be classified into three states of the “normal state”, a “contaminated state”, and the “abnormal orientation”. In addition, in a case where the light sources are not turned on due to a broken wire of an electric cable, the image may appear completely dark. In this case, the determination can be performed by determining whether all the pixel values are smaller than a predetermined value. In this case, the states of the light sources may be classified into four states, which are the “normal state”, the “deteriorated state”, the “abnormal orientation”, and an “unlit state”.

In the above-described embodiments, the states of the light sources are classified into the three states, which are the “normal state”, the “deteriorated state”, and the “abnormal orientation”, but since the “deteriorated state” progresses over time, the “deteriorated state” may be determined in a stepwise manner. For example, in a case where the difference between the imaging brightness image and the reference brightness image becomes larger than a predetermined threshold value Th1, a warning may be displayed, and in a case where the difference becomes larger than a predetermined threshold value Th2, which is larger than the predetermined threshold value Th1, the state of the light source may be determined to be the “deteriorated state”.

In the above-described embodiments, the state of each of the light sources is displayed according to the type of abnormality, but the display method is not limited to the above example. For example, the normal light source numbers may be displayed, or the abnormal light source numbers may be displayed collectively without categorizing by the type of abnormality.

According to the embodiments of the present disclosure, it is possible to identify the cause of an illuminance change on the inspection target in the appearance inspection.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2024-176163, which was filed on Oct. 7, 2024 and which is hereby incorporated by reference herein in its entirety.

What is claimed is:

1. An image processing apparatus comprising:
at least one processor; and
at least one memory that is in communication with the at least one processor, wherein the at least one memory stores instructions for causing the at least one processor and the at least one memory to:
acquire a brightness of an image captured by imaging a reference reflection plate when a plurality of light sources is sequentially turned on;
acquire a brightness of a reference corresponding to the brightness of the image;
determine whether a respective state of each light source included in the plurality of light sources is normal or abnormal based on the brightness of the image and the brightness of the reference; and
in a case where the respective state of a light source included in the plurality of light sources is abnormal, identify a type of abnormality.

2. The image processing apparatus according to claim 1, wherein the at least one processor and the at least one memory determine whether the respective state of each light source included in the plurality of light sources is normal or abnormal based on a difference between the brightness of the image and the brightness of the reference.

3. The image processing apparatus according to claim 1, wherein the type of abnormality is any of deterioration of a light source, an abnormal orientation of a light source, contamination, and an unlit state.

4. The image processing apparatus according to claim 1, wherein the at least one memory further stores instructions for causing the at least one processor and the at least one memory to perform a comparison based on a difference between the brightness of the image and the brightness of the reference at a same position in the reference reflection plate.

5. The image processing apparatus according to claim 1, wherein the at least one memory further stores instructions for causing the at least one processor and the at least one memory to perform inspection processing based on an image acquired by imaging a target object.

6. The image processing apparatus according to claim 1, wherein the at least one memory further stores instructions for causing the at least one processor and the at least one memory to control a display to display the identified type of abnormality.

7. The image processing apparatus according to claim 1, wherein the at least one processor and the at least one memory determine that the type of abnormality is an abnormal orientation of the light source in a case where a difference in spatial brightness distribution between the image and the reference is equal to or greater than a threshold value.

8. The image processing apparatus according to claim 1, wherein the at least one processor and the at least one memory determine that the type of abnormality is deterioration of the light source in a case where a difference in overall brightness between the image and the reference is equal to or greater than a threshold value.

9. The image processing apparatus according to claim 1, wherein the at least one processor and the at least one memory determine that the type of abnormality is a light source that is unlit when the reference reflection plate is captured, in a case where the brightness of the image is less than a threshold value.

10. An image processing method comprising:
acquiring a brightness of an image captured by imaging a reference reflection plate when a plurality of light sources is sequentially turned on;
acquiring a brightness of a reference corresponding to the brightness of the image;
determining whether a respective state of each light source included in the plurality of light sources is normal or abnormal based on the brightness of the image and the brightness of the reference; and
in a case where the respective state of a light source included in the plurality of light sources is abnormal, identifying a type of abnormality.

11. A non-transitory computer-readable storage medium storing instructions that, when executed by a computer, cause the computer to perform an image processing method, the image processing method comprising:
acquiring a brightness of an image captured by imaging a reference reflection plate when a plurality of light sources is sequentially turned on;
acquiring a brightness of a reference corresponding to the brightness of the image;
determining whether a respective state of each light source included in the plurality of light sources is normal or abnormal based on the brightness of the image and the brightness of the reference; and
in a case where the respective state of a light source included in the plurality of light sources is abnormal, identifying a type of abnormality.
